(19) United States
(12) Patent Application Publication
(10) Pub. No.: US 2013/0338249 A1
(43) Pub. Date: Dec. 19, 2013

(54) LOW RESILIENCE FLEXIBLE POLYURETHANE FOAM AND PROCESS FOR ITS PRODUCTION

(71) Applicant: ASAHI GLASS COMPANY, LIMTED, Chiyoda-ku (JP)

(72) Inventors: Takayuki SASAKI, Chiyoda-ku (JP); Daisuke KAKU, Chiyoda-ku (JP); Takashi ITO, Chiyoda-ku (JP)

(73) Assignee: ASAHI GLASS COMPANY, LIMITED, Chiyoda-ku (JP)

(21) Appl. No.: 13/975,631

(22) Filed: Aug. 26, 2013

Related U.S. Application Data
(63) Continuation of application No. PCT/JP2012/054155, filed on Feb. 21, 2012.

(30) Foreign Application Priority Data
Feb. 25, 2011 (JP) 2011-040024

(51) Int. Cl. C08J 9/00

(52) U.S. Cl. CPC C08J 9/0042
USPC 521/110

(57) ABSTRACT

To provide a process for producing a flexible polyurethane foam which is excellent in low resiliency without using a plasticizer which is excellent in durability, and at the same time, which has high air permeability.

A process for producing a flexible polyurethane foam, which comprises reacting a polyol mixture containing the-polyether polyol (A) obtained using a DMC catalyst; the-polyether polyol (B) and the polyether monool (D), with a polyisocyanate compound, in the presence of a foam stabilizer (X) which is a silicone type compound, a urethane-forming catalyst and a blowing agent, at an isocyanate index of at least 90, wherein:

Foam stabilizer (X) is a silicone type compound containing one or more types of dimethylpolysiloxane represented by the following formula (I):

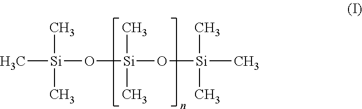

where n is from 1 to 30 on average.

This application is a continuation of PCT Application No. PCT/JP2012/054155, filed on Feb. 21, 2012, which is based upon and claims the benefit of priority from Japanese Patent Application No. 2011-040024 filed on Feb. 25, 2011. The contents of those applications are incorporated herein by reference in its entirety.

### TECHNICAL FIELD

The present invention relates to a low resilience flexible polyurethane foam and a process for its production.

### BACKGROUND ART

Heretofore, a flexible polyurethane foam having a low rebound resilience i.e. low resiliency, has been used for a shock absorber, a sound absorbent or a vibration absorber. Further, it is known that when it is used as a cushion material for chairs, mattress, etc., the body pressure distribution will be more uniform, whereby feeling of fatigue, pressure sores, etc. will be reduced.

On the other hand, it is known that the air permeability of a low resilience flexible polyurethane foam usually decreases as the resiliency decreases. In a case where a low resilience polyurethane foam is applied particularly to bedding, if the air permeability is low, humidity (mainly released from human body) tends to be hardly dissipated, thus leading to a so-called humid state. A low resilience polyurethane foam for bedding has been required to reduce such a humid state and to dissipate the heat and humidity. Further, when the usage state of bedding is taken into consideration, as a flexible polyurethane foam is to be used in a compressed state, it is required to exhibit substantially higher air permeability in a test for air permeability as measured usually in a non-compressed state. Further, in consideration of the fact that it is compressed in a humid state, the durability in a humidified state is required. As an index for the durability in a humidified state, the wet heat compression set may be mentioned.

As a method to solve the above problems and to improve the air permeability of a low resilience polyurethane foam, a method of employing a low molecular weight polyhydric alcohol as a raw material polyol has been proposed, as disclosed in Patent Document 1. However, the low resilience polyurethane foam obtained by such a method has a problem with respect to the durability, and the restoration performance tends to gradually deteriorate. Further, in Patent Document 2, a low resilience polyurethane foam is obtained by using a polyether polyester polyol and a phosphorus-containing compound. However, the phosphorus-containing compound shows the same behavior as a plasticizer and is likely to elute from the flexible polyurethane foam, whereby it is expected to be difficult to maintain the performance after repeating the washing.

Further, Patent Document 3 discloses a method for producing a low resilience polyurethane foam having a good air permeability by using a monool in combination for the production. However, this method has a problem that the after-mentioned durability in a humidified state is poor. Patent Document 4 discloses a flexible polyurethane foam of which permeability is secured by combination of a specific polyol and monool, but such a flexible polyurethane foam has a density of so high as 55 kg/m³ and thus is heavy, and therefore there is a problem such that handling efficiency is poor at the time of processing into e.g. mattresses. Further, in Patent Document 5, silicone oil is employed for securing the air permeability, in combination with a polyester polyol, but no specific structure is disclosed therein.

### PRIOR ART DOCUMENTS

### Patent Documents

Patent Document 1: JP-A-2004-2594
Patent Document 2: JP-A-9-151234
Patent Document 3: JP-A-2004-300352
Patent Document 4: WO2006/115169
Patent Document 5: JP-A-2001-269062

### DISCLOSURE OF INVENTION

### Technical Problem

It is an object of the present invention to provide a flexible polyurethane foam which is excellent in low resiliency without using a plasticizer for imparting flexibility, which is excellent in durability in a humidified state and which has high air permeability at the same time, and a process for its production.

### Solution to Problem

The present invention provides the following [1] to [11].

[1] A process for producing a flexible polyurethane foam, which comprises reacting a polyol mixture containing the following polyol (A), the following polyol (B) and the following monool (D), with a polyisocyanate compound, in the presence of a foam stabilizer (X) which is a silicone type compound, a urethane-forming catalyst and a blowing agent, at an isocyanate index of at least 90, wherein:

Polyol (A) is a polyether polyol having an average number of hydroxy groups of from 2 to 3 and a hydroxy value of from 10 to 90 mgKOH/g, obtained by ring-opening addition polymerization of an alkylene oxide to an initiator by using a double metal cyanide complex catalyst;

Polyol (B) is a polyether polyol having an average number of hydroxy groups of from 2 to 3 and a hydroxy value of from 15 to 250 mgKOH/g, other than the polyol (A);

Monool (D) is a polyether monool having a hydroxy value of from 10 to 200 mgKOH/g, obtained by ring-opening addition polymerization of an alkylene oxide to an initiator by using a double metal cyanide complex catalyst; and

Foam stabilizer (X) is a silicone type compound containing one or more types of dimethylpolysiloxane represented by the following formula (I):

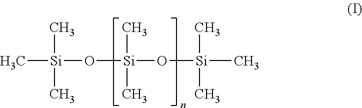

where n is from 1 to 30 on average,
in an amount of from 0.01 to 1.0 part by mass per 100 parts by mass of the above polyol mixture.
[2] The process for producing a flexible polyurethane foam according to the above [1], wherein the foam stabilizer (X) is contained in an amount of from 0.1 to 8.0 parts by mass per 100 parts by mass of the above polyol mixture.
[3] The process for producing a flexible polyurethane foam according to the above [1] or [2], wherein the dimethylpolysiloxane represented by the formula (I) is contained in an amount of from 0.7 to 95.0 mass % in 100 mass % of the foam stabilizer (X).
[4] The process for producing a flexible polyurethane foam according to any one of the above [1] to [3], wherein the polyol (A) is contained in an amount of from 10 to 30 mass %, the polyol (B) is contained in an amount of from 50 to 80 mass %, and the monool (D) is contained in an amount of from 2 to 24 mass %, in the polyol mixture.
[5] The process for producing a flexible polyurethane foam according to any one of the above [1] to [4], wherein the polyol (A) is a polyoxypropylene polyol obtained by ring-opening addition polymerization of only propylene oxide to an initiator.
[6] The process for producing a flexible polyurethane foam according to any one of the above [1] to [5], wherein the blowing agent is water.
[7] The process for producing a flexible polyurethane foam according to any one of the above [1] to [6], wherein the monool (D) is a polyoxypropylene monool obtained by ring-opening addition polymerization of only propylene oxide to an initiator.
[8] The process for producing a flexible polyurethane foam according to any one of the above [1] to [7], wherein the polyisocyanate compound is at least one member selected from the group consisting of tolylene diisocyanate (TDI), diphenylmethane diisocyanate (MDI), polymethylenepolyphenyl polyisocyanate, xylylene diisocyanate (XDI), isophorone diisocyanate (IPDI), hexamethylene diisocyanate (HMDI) and their modified products.
[9] The process for producing a flexible polyurethane foam according to any one of the above [1] to [8], wherein the polyol mixture further contains the following polyol (C) in an amount of at most 10 mass % based on the entire polyol mixture:

Polyol (C) is a polyol having an average number of hydroxy groups of from 2 to 6 and a hydroxy value of from 300 to 1,830 mgKOH/g.

[10]. The process for producing a flexible polyurethane foam according to any one of the above [1] to [9], wherein the flexible polyurethane foam has a rebound resilience of the core of at most 20% and an air permeability of from 30 to 160 L/min.
[11]. The process for producing a flexible polyurethane foam according to any one of the above [1] to [10], wherein the flexible polyurethane foam has a hysteresis loss rate of the core, measured in accordance with JIS K6400 (1997), of at most 70%.

### Advantageous Effects of Invention

According to the process for producing a flexible polyurethane foam of the present invention, it is possible to produce a flexible polyurethane foam which is excellent in low resiliency without using a plasticizer, which is excellent in durability in a humidified state and which has high air permeability at the same time.

### DESCRIPTION OF EMBODIMENTS

In the present invention, a flexible polyurethane foam is produced by reacting a polyol mixture with a polyisocyanate compound, in the presence of a urethane-forming catalyst, a blowing agent and a foam stabilizer containing dimethylpolysiloxane with a specific polymerization degree, represented by the formula (I). Further, “the silicone type compound” in the present invention means dimethylpolysiloxane, a derivative thereof or a mixture thereof.

In this specification, materials comprise the polyol mixture, the polyisocyanate compound, the urethane-forming catalyst, the blowing agent and the foam stabilizer. Now, the respective materials will be explained.

### Polyol Mixture

The polyol mixture to be used in the present invention contains the following polyol (A), polyol (B) and monool (D). Further, it preferably contains polyol (C).

Polyol (A)

The polyol (A) in the present invention is a polyether polyol (a polyoxyalkylene polyol) having an average number of hydroxy groups of from 2 to 3 and a hydroxy value of from 10 to 90 mgKOH/g, obtained by ring-opening addition polymerization of an alkylene oxide to an initiator by using a double metal cyanide complex catalyst (DMC catalyst). That is, the polyol (A) is a polyether polyol having a polyoxyalkylene chain obtained by ring-opening addition polymerization of an alkylene oxide by using a double metal cyanide complex catalyst. By the use of the double metal cyanide complex catalyst, a by-product monool can be reduced, and a polyol having a narrow molecular weight distribution can be produced. The polyol having a narrow molecular weight distribution has a low viscosity as compared with a polyol having a wide molecular weight distribution in a molecular weight region of the same level (a polyol having the same hydroxy value), whereby it is excellent in blendability of reactive materials, and the stability of foam during the production of the flexible polyurethane foam is improved.

As the double metal cyanide complex catalyst, one disclosed in JP-B-46-27250 may, for example, be used. As a specific example, a complex containing zinc hexacyanocobaltate as the main component may be mentioned, and its ether and/or alcohol complex is preferred. The ether may, for example, be preferably ethylene glycol dimethyl ether (glyme), diethylene glycol dimethyl ether (diglyme), ethylene glycol mono-tert-butyl ether (METB), ethylene glycol mono-tert-pentyl ether (METP), diethylene glycol mono-tert-butyl ether (DETB) or tripropylene glycol monomethyl ether (TPME). The alcohol may, for example, be preferably tert-butyl alcohol.

The alkylene oxide to be used for the production of the polyol (A) may, for example, be ethylene oxide, propylene oxide, 1,2-epoxybutane or 2,3-epoxybutane. Among them, propylene oxide, or a combination of propylene oxide and ethylene oxide, is preferred. Particularly preferred is propylene oxide alone. That is, as the polyol (A), a polyoxypropylene polyol obtained by ring-opening addition polymerization of only propylene oxide to an initiator is preferred. It is preferred to use only propylene oxide, whereby the durability in a humidified state will be improved.

As the initiator to be used for the production of the polyol (A), a compound having 2 or 3 active hydrogen atoms in its molecule may be used alone, or such compounds may be used in combination. Specific examples of the compound having 2 active hydrogen atoms include ethylene glycol, propylene glycol, 1,4-butanediol, diethylene glycol and dipropylene glycol. Further, specific examples of the compound having 3 active hydrogen atoms include glycerol and trimethylol propane. Further, it is preferred to employ a polyether polyol having a high hydroxy value obtained by ring-opening addition polymerization of an alkylene oxide, preferably propylene oxide, to such a compound. Specifically, it is preferred to employ a high hydroxy value polyether polyol (preferably polyoxypropylene polyol) having a molecular weight per hydroxy group of from about 200 to 500, i.e. a hydroxy value of from 110 to 280 mgKOH/g.

In the present invention, the polyol (A) has an average number of hydroxy groups of from 2 to 3. In the present invention, the average number of hydroxy groups means an average in number of active hydrogen atoms in the initiator. By adjusting the average number of hydroxy groups to from 2 to 3, it is possible to avoid a trouble of remarkable deterioration of the physical properties such as the dry heat compression set of the obtainable flexible polyurethane foam. Further, it is possible to avoid troubles such as a decrease in elongation of the obtainable flexible polyurethane foam and an increase in hardness to deteriorate the physical properties such as the tensile strength. As the polyol (A), it is preferred to employ a polyether diol having 2 hydroxy groups in an amount of from 50 to 100 mass % based on the polyol (A), whereby the temperature sensitivity may easily be suppressed.

In the present invention, the polyol (A) has a hydroxy value of from 10 to 90 mgKOH/g. By adjusting the hydroxy value to be at least 10 mgKOH/g, it is possible to constantly produce the flexible polyurethane foam by suppressing collapse, etc. Further, by adjusting the hydroxy value to be at most 90 mgKOH/g, it is possible to control the rebound resilience to be low without impairing the flexibility of the flexible polyurethane foam thereby produced. The hydroxy value of the polyol (A) is more preferably from 10 to 60 mgKOH/g, most preferably from 15 to 60 mgKOH/g. In the present invention, the unsaturation value of the polyol (A) is preferably at most 0.05 meq/g, further preferably at most 0.01 meq/g, particularly preferably at most 0.006 meq/g. By adjusting the unsaturation value to be at most 0.05 meq/g, it is possible to avoid a trouble of deterioration of the durability of the obtainable flexible polyurethane foam. The lower limit of the unsaturation value is ideally 0 meq/g.

The polyol (A) in the present invention may be a polymer-dispersed polyol. The polyol (A) being a polymer-dispersed polyol means that it constitutes a dispersion system wherein the polyol (A) is a base polyol (dispersing medium), and fine polymer particles (dispersoid) are stably dispersed.

As the fine polymer particles, an addition polymerization type polymer or a condensation polymerization type polymer may be mentioned. The addition polymerization type polymer may, for example, be obtained by homopolymerizing or copolymerizing a monomer such as acrylonitrile, styrene, a methacrylate or an acrylate. Further, the condensation polymerization type polymer may, for example, be polyester, polyurea, polyurethane or polymethylol melamine. By the presence of fine polymer particles in the polyol, the hydroxy value of the polyol can be controlled to be low, and it is effective to improve the mechanical properties such that the hardness of the flexible polyurethane foam can be increased. The content of the fine polymer particles in the polymer-dispersed polyol is not particularly limited, but it is preferably from 0 to 5 mass %, based on the entire polyol (A). Here, various physical properties (such as the unsaturation value, the hydroxy value, etc.) as the polyol of such a polymer-dispersed polyol are considered with respect to the base polyol excluding the fine polymer particles.

Polyol (B)

The polyol (B) in the present invention is a polyether polyol having an average number of hydroxy groups of from 2 to 3 and a hydroxy value of from 15 to 250 mgKOH/g and is a polyether polyol other than the above polyol (A). That is, it is a polyether polyol obtained by ring-opening addition polymerization of an alkylene oxide to an initiator by means of an alkylene oxide ring-opening addition polymerization catalyst. Here, a polyether polyol produced by using a double metal cyanide complex catalyst as the alkylene oxide ring-opening addition polymerization catalyst, is not included in the polyol (B).

The alkylene oxide ring-opening addition polymerization catalyst to be used for the production of the polyol (B) is preferably a phosphazenium compound, a Lewis acid compound or an alkali metal compound catalyst. Among them, the alkali metal compound catalyst is particularly preferred. As the alkali metal compound catalyst, potassium hydroxide (KOH) or cesium hydroxide (CsOH) may, for example, be mentioned.

The alkylene oxide to be used for the production of the polyol (B) may, for example, be ethylene oxide, propylene oxide, 1,2-epoxybutane or 2,3-epoxybutane. Among them, propylene oxide, or a combination of propylene oxide and ethylene oxide, is preferred.

As the polyol (B), it is preferred to employ a polyoxypropylene polyol obtainable by ring-opening addition polymerization of only propylene oxide to an initiator, whereby the durability in a humidified state will be improved. Further, as the polyol (B), it is preferred to use a polyoxypropylene polyol obtainable by ring-opening addition polymerization of only propylene oxide to an initiator and a polyoxypropyleneoxyethylene polyol having an oxyethylene group content of from 50 to 100 mass % in the oxyalkylene groups, obtainable by ring-opening addition polymerization of a mixture of propylene oxide and ethylene oxide, in combination, whereby the durability in a humidified state will further be improved. In a case where such a polyoxypropyleneoxyethylene polyol is to be used, it is preferably used in an amount of from 1 to 20 mass %, more preferably from 2 to 10 mass %, in the polyol (B).

As the initiator to be used for the production of the polyol (B), a compound having 2 or 3 active hydrogen atoms in its molecule may be used alone or such compounds may be used in combination. Specific examples of the compound having 2 or 3 active hydrogen atoms include a polyhydric alcohol such as ethylene glycol, propylene glycol, 1,4-butanediol, diethylene glycol, dipropylene glycol, glycerol or trimethylol propane; a polyhydric phenol such as bisphenol A; and an amine such as monoethanolamine, diethanolamine, triethanolamine or piperazine. Among them, a polyhydric alcohol is particularly preferred. Further, it is preferred to employ a high hydroxy value polyether polyol obtained by ring-opening addition polymerization of an alkylene oxide, preferably propylene oxide, to such a compound.

In the present invention, the average number of hydroxy groups in the polyol (B) is from 2 to 3. By adjusting the average number of hydroxy groups to from 2 to 3, it is possible to avoid a trouble of remarkable deterioration of the physical properties such as the dry heat compression set of the obtainable flexible polyurethane foam, and it is possible to avoid troubles such as a decrease in elongation of the obtainable flexible polyurethane foam or an increase in hardness to deteriorate the physical properties such as the tensile strength.

The average number of hydroxy groups in the polyol (B) is preferably from 2.0 to 2.7, more preferably from 2.0 to 2.6. By adjusting the average number of hydroxy groups in the polyol (B) within the above range, it is possible to control the rebound resilience to be low and it is possible to obtain a flexible urethane foam showing little change in hardness against a temperature change (having low temperature sensitivity).

Further, as the polyol (B), it is preferred to use a polyether diol having an average of 2 hydroxy groups and a polyether triol having an average of 3 hydroxy groups, in combination. The proportion of the polyether diol having an average of 2 hydroxy groups in the polyol (B) is preferably at least 40 mass %, more preferably at least 45 mass % in the polyol (B). By adjusting the average number of hydroxy groups within the above range, the rebound resilience can be controlled to be low, and it is possible to obtain a flexible urethane foam showing little change in hardness against a temperature change (having low temperature sensitivity).

In the present invention, the hydroxy value of the polyol (B) is from 15 to 250 mgKOH/g. By adjusting the hydroxy value to be at least 15 mgKOH/g, it is possible to constantly produce the flexible polyurethane foam by suppressing collapse, etc. Further, by adjusting the hydroxy value to be at most 250 mgKOH/g, it is possible to control the rebound resilience to be low without impairing the flexibility of the flexible polyurethane foam thereby produced.

As the polyol (B), it is preferred to employ a polyol having a hydroxy value of from 100 to 250 mgKOH/g, more preferably a polyol having a hydroxy value of from 100 to 200 mgKOH/g. Further, as the polyol (B), it is more preferred to use a polyol having a hydroxy value of from 100 to 250 mgKOH/g, more preferably from 100 to 200 mgKOH/g, and a polyol having a hydroxy value of from 15 to 99 mgKOH/g, more preferably from 15 to 60 mgKOH/g in combination.

The polyol (B) in the present invention may be a polymer-dispersed polyol. As the polymer for fine polymer particles, the same one as described above with respect to the polyol (A) may, for example, be mentioned. Further, the content of the fine polymer particles in the polymer-dispersed polyol is not particularly limited, but it is preferably from 0 to 10 mass %, based on the entire polyol (B).

As the polyol (B) in the present invention, it is preferred to employ a polyoxypropylene polyol having a hydroxy value of from 100 to 250 mgKOH/g (more preferably from 100 to 200 mgKOH/g), obtainable by ring-opening addition polymerization of only propylene oxide to an initiator, whereby the durability in a humidified state will be improved. Further, as the polyol (B), it is particularly preferred to use a polyoxypropylene polyol having a hydroxy value of from 100 to 250 mgKOH/g (more preferably from 100 to 200 mgKOH/g), obtainable by ring-opening addition polymerization of only propylene oxide to an initiator, and a polyoxypropyleneoxyethylene polyol having an oxyethylene group content of from 50 to 100 mass % and a hydroxy value of from 15 to 99 mgKOH/g (more preferably from 15 to 60 mgKOH/g), obtainable by ring-opening addition polymerization of a mixture of propylene oxide and ethylene oxide, in combination, whereby the durability in a humidified state will further be improved.

Polyol (C)

The polyol (C) in the present invention is a polyol having an average number of hydroxy groups of from 2 to 6 and a hydroxy value of from 300 to 1,830 mgKOH/g. The average number of hydroxy groups of the polyol (C) is particularly preferably from 3 to 4. Further, the hydroxy value of the polyol (C) is particularly preferably from 300 to 600 mgKOH/g. The polyol to be used as the polyol (C) may, for example, be a polyhydric alcohol, an amine having from 2 to 6 hydroxy groups, a polyester polyol, a polyether polyol or a polycarbonate polyol. By the use of the polyol (C), it functions as a crosslinking agent, whereby the mechanical properties such as the hardness will be improved. Further, in the present invention, it is observed that the polyol (C) has a cell-opening effect, and addition of the polyol (C) is effective to improve the air permeability. Especially, also in a case where a flexible polyurethane foam having a low density (light weight) is to be produced by using a large amount of a blowing agent, the foam stability will be good.

The polyhydric alcohol may, for example, be ethylene glycol, propylene glycol, 1,4-butanediol, dipropylene glycol, glycerol, diglycerol or pentaerythritol. The amine having from 2 to 6 hydroxy groups may, for example, be diethanolamine or triethanolamine. The polyether polyol may, for example, be a polyether polyol obtained by ring-opening addition polymerization of an alkylene oxide to an initiator. The initiator to be used for the production of the polyol (C) which is a polyether polyol, may, for example, be a polyhydric alcohol which may be used also as the polyol (C), or an initiator to be used for the production of the polyol (B).

The alkylene oxide to be used for the production of the polyol (C) which is a polyether polyol, may, for example, be ethylene oxide, propylene oxide, 1,2-epoxybutane or 2,3-epoxybutane. Among them, propylene oxide or a combination of propylene oxide and ethylene oxide, is preferred. Particularly preferred is propylene oxide alone. That is, as the polyol (C) which is a polyether polyol, a polyoxypropylene polyol obtained by ring-opening addition polymerization of only propylene oxide to an initiator, is preferred. As the polyol (C), a polyether polyol is preferred, and a polyoxypropylene polyol is particularly preferred among them. The use of propylene oxide alone is preferred, since the durability in a humidified state will thereby be improved. As the polyol (C), one type may be used alone, or two or more types may be used in combination.

Monool (D)

The monool (D) in the present invention is a polyether monool having a hydroxy value of from 10 to 200 mgKOH/g, obtained by ring-opening addition polymerization of an alkylene oxide to an initiator having one active hydrogen by using a double metal cyanide complex catalyst.

In the present invention, the monool (D) has an average number of hydroxy groups of 1. Further, the monool (D) has a hydroxy value of particularly preferably from 10 to 120 mgKOH/g.

The alkylene oxide to be used for the production of the monool (D) may, for example, be ethylene oxide, propylene oxide, 1,2-epoxybutane or 2,3-epoxybutane.

Among them, propylene oxide, or a combination of propylene oxide and ethylene oxide, is preferred. Particularly preferred is propylene oxide alone. That is, the monool (D) is preferably a polyoxypropylene monool obtained by ring-opening addition polymerization of only propylene oxide to an initiator. The use of only propylene oxide is preferred, since the durability in a humidified state will be thereby improved.

As the initiator to be used for the production of the monool (D), a compound having only one active hydrogen atom, is used. Specifically, it may, for example, be a monool such as methanol, ethanol, n-propyl alcohol, isopropyl alcohol, n-butyl alcohol or tert-butyl alcohol; a monohydric phenol such as phenol or nonylphenol; or a secondary amine such as dimethylamine or diethylamine.

Polyol Mixture

In the polyol mixture of the present invention, the proportions of the polyol (A) and the polyol (B) are such that the proportion of the polyol (A) to the total (100 mass %) of the polyol (A) and the polyol (B) is preferably from 5 to 50 mass %, more preferably from 10 to 30 mass %. By adjusting the proportion of the polyol (A) in the polyol mixture to be within the above range, it is possible to obtain a flexible polyurethane foam having low resiliency and showing little change in hardness and rebound resilience against a temperature change (having low temperature sensitivity).

Further, in the polyol mixture (100 mass %), the proportion of the total of the polyol (A) and the polyol (B) is preferably at least 75 mass %, more preferably at least 80 mass %, particularly preferably at least 85 mass %, especially preferably at least 90 mass %. By adjusting the proportion of the total of the polyol (A) and the polyol (B) in the polyol mixture to be within the above range, it is possible to obtain a flexible polyurethane foam which is excellent in low resiliency and durability and which has good air permeability.

Further, the proportion of the monool (D) is preferably from 1 to 30 parts by mass per 100 parts by mass of the total of the polyol (A) and the polyol (B). When tin 2-ethylhexanoate is used as a urethane-forming catalyst, the proportion of the monool (D) is more preferably from 1 to 10 parts by mass, most preferably from 2 to 8 parts by mass. Further, when dibutyltin dilaurate or dioctyltin dilaurate is used as a urethane-forming catalyst, it is more preferably from 2 to 30 parts by mass. By adjusting the proportion of the monool (D) to be within the above range, it is possible to obtain a flexible polyurethane foam which is excellent in low resiliency and durability and which has good air permeability.

Further, the proportion of the polyol (C) in the polyol mixture (100 mass %) is preferably from 0 to 10 mass %, more preferably from 0 to 5 mass %, particularly preferably from 0.5 to 2 mass %. By adjusting the proportion of the polyol (C) to be within the above range, it is possible to improve the air permeability while further lowering the low resiliency of the flexible polyurethane foam.

Further, the polyol mixture in the present invention may also contain another polyol (E) which is not classified in any of the polyol (A), the polyol (B), the polyol (C) and the monool (D). The proportion of such another polyol (E) is preferably at most 10 mass %, more preferably at most 5 mass %, particularly preferably 0 mass %, in the polyol mixture (100 mass %). The proportion of such another polyol (E) being 0 mass % means that the polyol mixture comprises the polyol (A), the polyol (B) and the monool (D), and if necessary, the polyol (C), but does not contain another polyol (E).

In the present invention, a preferred composition of the polyol mixture (100 mass %) may specifically comprise, for example, from 10 to 30 mass % of the polyol (A), from 50 to 80 mass % of the polyol (B), from 0 to 5 mass % of the polyol (C) and from 2 to 24 mass % of the monool (D).

### Polyisocyanate Compound

The polyisocyanate compound to be used in the present invention is not particularly limited, and it may, for example, be an aromatic, alicyclic or aliphatic polyisocyanate having at least two isocyanate groups, a mixture of at least two such polyisocyanates, or a modified polyisocyanate obtainable by modifying such a polyisocyanate.

A specific example of the polyisocyanate may, for example, be tolylene diisocyanate (TDI), diphenylmethane diisocyanate (MDI), polymethylenepolyphenyl polyisocyanate (also referred to as polymeric MDI or crude MDI), xylylene diisocyanate (XDI), isophorone diisocyanate (IPDI) or hexamethylene diisocyanate (HMDI). Polymeric MDI is commercially available as Milionate MR (manufactured by Nippon Polyurethane Industry Co., Ltd.) or LupranateM20S (manufactured by BASF Corporation). Further, a specific example of the modified polyisocyanate may, for example, be a prepolymer type modified product, a nurate modified product, a urea modified product or a carbodiimide modified product of each of the above polyisocyanates. Among them, TDI, MDI, crude MDI or a modified product thereof is preferred. Further, it is preferred to employ TDI, crude MDI or a modified product thereof (particularly preferred is a prepolymer type modified product) among them, whereby the foam stability will be improved, or the durability will be improved. Especially, it is preferred to employ a polyisocyanate compound having a relatively low reactivity among TDI, crude MDI and modified products thereof, whereby the air permeability will be improved. Specifically, TDI is preferred as a polyisocyanate compound. Especially, more preferred is a TDI mixture wherein the proportion of 2,6-TDI is at least 20 mass %, since its foam stability is good.

The amount of the polyisocyanate compound to be used is such an amount that the proportion of the polyisocyanate compound to all active hydrogen-containing compounds in the material is at least 90 by the isocyanate index. The active hydrogen-containing compound is meant for the polyol mixture and water or the like which is useful as a blowing agent. The isocyanate index is represented by 100 times a numerical value obtained by dividing the equivalent amount of isocyanate groups in the polyisocyanate compound by the equivalent amount of the total of all active hydrogen atoms in all active hydrogen-containing compounds in the material including polyols, water, etc.

In the process for producing a flexible polyurethane foam of the present invention, the proportion of all active hydrogen-containing compounds and the polyisocyanate compound in the material is adjusted to be at least 90 by the isocyanate index. If the above proportion is less than 90 by the isocyanate index, the polyols are used excessively, the influence as the plasticizer tends to be large, and the washing durability tends to deteriorate, such being undesirable. Further, such is undesirable also from such a viewpoint that the urethane-forming catalyst tends to be readily dissipated, or the produced flexible polyurethane foam is likely to undergo a color change. The above proportion is preferably from 90 to 130, more preferably from 95 to 110, particularly preferably from 100 to 110, by the isocyanate index.

### Urethane-Forming Catalyst

As the urethane-forming catalyst for the reaction of the polyol with the polyisocyanate compound, any catalyst may be used which promotes the urethane-forming reaction. For example, a tertiary amine such as triethylene diamine, bis(2-dimethylaminoethyl)ether or N,N,N′,N′-tetramethylhexamethylene diamine; a metal carboxylate such as potassium acetate or potassium 2-ethylhexanoate, or an organic metal compound such as stannous octoate, dibutyltin dilaurate or dioctyltin dilaurate, may be mentioned.

Foam Stabilizer (X)

In the present invention, a foam stabilizer (X) made of a silicone type compound is used. The foam stabilizer (X) contains one or more types of dimethylpolysiloxane represented by the following formula (I) wherein n is from 1 to 30 on average (hereinafter, also referred to as “dimethylpolysiloxane (I)”).

Here, even when the compound represented by the formula (I) (dimethylpolysiloxane) is produced under a particular production condition, the resulting product is a mixture of compounds having different values of n, and therefore, n is represented by an average value.

As the average value of n of dimethylpolysiloxane (I) becomes large, the amount of addition can be reduced for the effect of improving the air permeability. When the average value of n in the dimethylpolysiloxane (I) is at most 30, it is possible to improve the air permeability without impairing the physical properties of the foam. Further, from the viewpoint of improving the foaming stability of the flexible polyurethane foam, the average value of n is preferably at most 28, more preferably at most 27, most preferably at most 25. From the viewpoint that the air permeability can be improved without increasing the amount of addition, the average value of n is preferably at least 2, more preferably at least 3, particularly preferably at least 7.

As the dimethylpolysiloxane (I), one type may be used alone, or two or more types differing in the average value of n may be used in combination. When two or more types are to be used in combination, the average value of n in each dimethylpolysiloxane (I) is within the above range.

As the dimethylpolysiloxane (I), commercial products are available. The commercial products containing components other than the dimethylpolysiloxane (I) may also be used. In such a case, among the components contained in the commercial products, dimethylpolysiloxane (I) and the silicone type compound other than the dimethylpolysiloxane (I) are included in the foam stabilizer (X) in the present invention, and the components which are not silicone type compounds are not included in the foam stabilizer (X).

The foam stabilizer (X) may contain such another silicone type compound other than the dimethylpolysiloxane (I) without impairing the effect of the present invention. As a specific example of such another silicone type compound, preferred is a silicone foam stabilizer containing a polyoxyalkylene/dimethylpolysiloxane copolymer as a main component, which has been used as a foam stabilizer. A commercially available foam stabilizer is a composition, and such a foam stabilizer composition may contain a polyoxyalkylene/dimethylpolysiloxane copolymer alone, or may contain another component in combination therewith. Such another component may, for example, be a polyalkylmethylsiloxane, a glycol or a polyoxyalkylene compound. As a foam stabilizer to be used in the present invention, a foam stabilizer composition comprising a polyoxyalkylene/dimethylpolysiloxane copolymer, a polyalkylmethylsiloxane and a polyoxyalkylene compound, is particularly preferred from the viewpoint of the stability of the foam. As an example of a commercial product of such a foam stabilizer composition, SZ-1327 (tradename), SZ-1328 (tradename) or SRX-298 (tradename) manufactured by Dow Corning Toray Co., Ltd. may be mentioned. Two or more of such silicone foam stabilizers may be used in combination, or a foam stabilizer other than the above specified foam stabilizers may be used in combination.

The amount of the foam stabilizer (X) to be added is preferably from 0.1 to 8.0 parts by mass, more preferably from 0.3 to 6.0 parts by mass, most preferably from 0.55 to 5.0 parts by mass, per 100 parts by mass of the polyol mixture.

When the amount of the foam stabilizer (X) to be used is at most the upper limit value of the above range, it is possible to secure the air permeability. Further, when it is at least the lower limit value of the above range, it is possible to stably produce a flexible polyurethane foam.

In the foam stabilizer (X), the amount of the dimethylpolysiloxane (I) to be used is preferably from 0.01 to 1.0 part by mass, more preferably from 0.015 to 0.8 part by mass, furthermore preferably from 0.025 to 0.6 part by mass, per 100 parts by mass of all of the polyols.

The proportion of the dimethylpolysiloxane (I) is preferably from 0.7 to 95.0 mass %, more preferably from 1.0 to 90 mass %, particularly preferably from 1.5 to 80 mass %, in 100 mass % of the foam stabilizer (X).

When the amount of the dimethylpolysiloxane (I) to be used is at most the above upper limit value per 100 parts by mass of all of the polyols, it is possible to obtain a foam which is excellent in air permeability and durability in a humid and hot state. Further, when it is at least the above lower limit value, it is possible to obtain a foam excellent in the air permeability.

When the proportion of the dimethylpolysiloxane (I) in 100 mass % of the foam stabilizer (X) is within the above range, it is possible to stably produce a foam excellent in the air permeability.

### Blowing Agent

The blowing agent is not particularly limited, and a known blowing agent such as a fluorinated hydrocarbon may be used. However, as the blowing agent to be used in the present invention, at least one member selected from the group consisting of water and an inert gas is preferred. The inert gas may specifically be, for example, air, nitrogen or carbon dioxide. Among them, water is preferred. That is, in the present invention, it is particularly preferred to employ only water as the blowing agent.

When water is used, the amount of the blowing agent is preferably at most 10 parts by mass, more preferably from 0.1 to 8 parts by mass, further preferably from 0.2 to 6.0 parts by mass, per 100 parts by mass of the polyol mixture. By changing the amount of the blowing agent to be used, it is possible to adjust the core density.

### Other Additives

At the time of producing the flexible polyurethane foam of the present invention, desired additives may also be used in addition to the above-described urethane-forming catalyst, blowing agent and foam stabilizer. As such additives, a filler such as potassium carbonate or barium sulfate; a surfactant such as an emulsifier; an aging-preventive agent such as an antioxidant or an ultraviolet absorber; a flame retardant, a plasticizer, a coloring agent, an antifungal agent, a cell opener, a dispersant and a discoloration-preventive agent may, for example, be mentioned.

### Foaming Method

The method for forming a flexible polyurethane foam of the present invention may be a method (mold method) wherein a reactive mixture is injected, foamed and molded in a closed mold, or a method (slab method) wherein a reactive mixture is foamed in an open system. A slab method is preferred. Specifically, foaming can be carried out by a known method such as a one shot method, a semiprepolymer method or a prepolymer method. For the production of a flexible polyurethane foam, a production apparatus commonly employed, may be used.

### Flexible Polyurethane Foam

The flexible polyurethane foam of the present invention is a flexible polyurethane foam which is produced by the above-described process. That is, the flexible polyurethane foam of the present invention is a flexible polyurethane foam produced by reacting a polyol mixture with a polyisocyanate compound in the presence of a urethane-forming catalyst, a blowing agent and a foam stabilizer, characterized in that the polyol mixture comprises the above-mentioned polyol (A), the above-mentioned polyol (B) and the above-mentioned monool (D), and the proportion of the polyisocyanate compound to the polyol mixture in the reaction is at least 90 by the isocyanate index.

The flexible polyurethane foam obtainable by the production process of the present invention is characterized by the low resiliency, and the rebound resilience of the core is preferably at most 20%, more preferably at most 18%, particularly preferably at most 16%, most preferably at most 15%. By adjusting the rebound resilience of the core to be at most 15%, sufficient low resiliency will be provided. The lower limit is usually 0%. The measurement of the rebound resilience of the core is carried out in accordance with JIS K6400 (1997 edition). Further, the “core” in the present invention is a portion obtained by removing the skin portion from the center portion of the flexible polyurethane foam.

The flexible polyurethane foam obtainable by the production process of the present invention is characterized in that the air permeability is good, and the air permeability is preferably from 30 to 160 L/min, more preferably from 40 to 140 L/min, particularly preferably from 50 to 120 L/min. The air permeability being within the above range means that a predetermined amount of air permeability is secured even in a compressed state. That is, the flexible polyurethane foam of the present invention is less likely to be humidified when applied to bedding. Here, the measurement of the air permeability is carried out by a method in accordance with JIS K6400 (1997 edition).

The flexible polyurethane foam obtainable by the production process of the present invention is characterized in that the durability is good. As indices for the durability, the dry heat compression set and the wet heat compression set are used. The flexible polyurethane foam of the present invention is characterized particularly in that the wet heat compression set as an index for the durability in a humidified state, is small. Here, each of the measurements of the dry heat compression set and the wet heat compression set is carried out in accordance with JIS K6400 (1997 edition). The wet heat compression set is an index showing the durability in a humidified state.

Regarding the compression set when the flexible polyurethane foam of the present invention is compressed 50% to the thickness of the foam, the dry heat compression set is preferably at most 6%, more preferably at most 5%, particularly preferably at most 4%, most preferably at most 3.5%. Further, of the flexible polyurethane foam of the present invention, the wet heat compression set is preferably at most 5%, more preferably at most 4%, particularly preferably at most 3.5%. Further, regarding the compression set when the foam is compressed 90% to the thickness of the foam, the dry heat compression set is preferably at most 12%, more preferably at most 10%, particularly preferably at most 8%, most preferably at most 7%. Further, of the flexible polyurethane foam of the present invention, the wet heat compression set is preferably at most 10%, more preferably at most 7%, particularly preferably at most 6%.

In the present invention, it is more preferred that the wet heat compression set by the 90% compression is small.

The density (core density) of the flexible polyurethane foam obtainable by the production process of the present invention is preferably from 20 to 110 kg/m³, more preferably from 22 to 80 kg/m³, more preferably from 25 to 70 kg/m³. Especially, the flexible polyurethane foam of the present invention is characterized in that even with a low density, it can be foamed and produced stably and yet is excellent in durability.

The flexible polyurethane foam obtainable by the production process of the present invention is characterized in that the hysteresis loss rate is low. The hysteresis loss rate is measured in accordance with JIS K6400 (1997 edition). When the hysteresis loss rate measured by a pressing board having a diameter of 200 mm in an atmosphere under a relative humidity of 50% at 23° C. is at most 70%, human can easily roll over when such a flexible polyurethane foam is actually used as a mattress, and it is thereby possible to offer comfortable sleep. It depends on the density of the flexible polyurethane foam, but the hysteresis loss rate is preferably at most 65%, particularly preferably at most 60%, most preferably at most 55%.

### Mechanism

In the present invention, when the polyol (A) has 2 hydroxy groups and a hydroxy value of from 10 to 90 mgKOH/g, it contains a polyol which is completely straight-chained with no branches and has an extremely long molecular chain. It is thereby possible to obtain a flexible polyurethane foam which exhibits low resiliency derived from the polyol (A) which is straight-chained and has an extremely long molecular chain and which has sufficient low resiliency, specifically the rebound resilience of the core being at most 20%. Further, when the polyol (A) has 3 hydroxy groups and a hydroxy value of from 10 to 90 mgKOH/g, by selectively combining a polyol having two hydroxy groups among the polyol (B), low resiliency can be obtained.

Further, since dimethylpolysiloxane with a specific polymerization degree, represented by the formula (I) is contained, it is possible to improve the air permeability without impairing the characteristics as a low resilience urethane foam.

### EXAMPLES

Now, the present invention will be described in further detail with reference to Examples, but the present invention is by no means restricted by the following Examples. Further, numerical values in Examples and Comparative Examples represent parts by mass. Further, the measurement of unsaturation values was carried out by a method in accordance with JIS K1557 (1970 edition).

### Materials

Polyether polyol A1: Using a potassium hydroxide catalyst and dipropylene glycol as an initiator, propylene oxide was subjected to ring-opening addition polymerization to a molecular weight of 1000, followed by refinement with magnesium silicate. Then, using the compound as an initiator, propylene oxide was subjected to ring-opening addition polymerization by using zinc hexacyanocobaltate-tert-butyl alcohol complex catalyst, to obtain a polyoxypropylene polyol having an average number of hydroxy groups of 2, a hydroxy value of 14 mgKOH/g and an unsaturation value of 0.005 meq/g.

Polyether polyol B1: Using a potassium hydroxide catalyst and dipropylene glycol as an initiator, propylene oxide was subjected to ring-opening addition polymerization, to obtain a polyoxypropylene polyol having an average number of hydroxy groups of 2 and a hydroxy value of 160 mgKOH/g.

Polyether polyol B2: Using a potassium hydroxide catalyst and glycerol as an initiator, propylene oxide was subjected to ring-opening addition polymerization, to obtain a polyoxypropylene polyol having an average number of hydroxy groups of 3 and a hydroxy value of 168 mgKOH/g.

Polyether polyol B3: Using a potassium hydroxide catalyst and glycerol as an initiator, a mixture of propylene oxide and ethylene oxide was subjected to ring-opening addition polymerization, to obtain a polyoxypropyleneoxyethylene polyol having an average number of hydroxy groups of 3, a hydroxy value of 48 mgKOH/g and a total oxyethylene group content of 80 mass %.

Polyether polyol C1: Using a potassium hydroxide catalyst and pentaerythritol as an initiator, propylene oxide was subjected to ring-opening addition polymerization, to obtain a polyoxypropylene polyol having an average number of hydroxy groups of 4 and a hydroxy value of 410 mgKOH/g.

Polyether monool D1: Using n-butyl alcohol as an initiator, propylene oxide was subjected to ring-opening addition polymerization by using zinc hexacyanocobaltate-tert-butyl alcohol complex catalyst, to obtain a polyoxypropylene monool having an average number of hydroxy groups of 1 and a hydroxy value of 16.7 mgKOH/g.

Blowing agent: Water

Catalyst A: Dioctyltin dilaurate (tradename: NEOSTANN U-810, manufactured by Nitto Kasei Co., Ltd.)

Catalyst B: Solution of triethylenediamine in dipropylene glycol (tradename: TEDA-L33, manufactured by TOSOH CORPORATION)

Catalyst C: Amine catalyst (tradename: Niax A-230, manufactured by Air Products and Chemicals, Inc.)

Catalyst D: Dibutyltin dilaurate (tradename: NEOSTANN U-100, manufactured by Nitto Kasei Co., Ltd.)

Foam stabilizer X-A: Silicone foam stabilizer (tradename: SZ-1327, manufactured by Dow Corning Toray Co., Ltd.)

Foam stabilizer X-B: Silicone foam stabilizer (tradename: SRX-298, manufactured by Dow Corning Toray Co., Ltd.)

Foam stabilizer X—C: Silicone foam stabilizer (tradename: SZ-1328, manufactured by Dow Corning Toray Co., Ltd.)

Dimethyl polysiloxane (X)

Dimethyl polysiloxane (X-1): Tradename: KF-96A-6cs, manufactured by Shin-Etsu Chemical Industry Co., Ltd, dimethyl polysiloxane represented by the above formula (I) wherein n is 7.3 on average. The kinematic viscosity at 25° C. is 6 mm²/s.

Dimethyl polysiloxane (X-2): Tradename: KF-96L-5cs, manufactured by Shin-Etsu Chemical Industry Co., Ltd, dimethyl polysiloxane represented by the above formula (I) wherein n is 7.0 on average. The kinematic viscosity at 25° C. is 5 mm²/s.

Dimethyl polysiloxane (X-3): Tradename: KF-96L-2cs, manufactured by Shin-Etsu Chemical Industry Co., Ltd, dimethyl polysiloxane represented by the above formula (I) wherein n is 2.5 on average. The kinematic viscosity at 25° C. is 2 mm²/s.

Dimethyl polysiloxane (X-4): Tradename: KF-96-20cs, manufactured by Shin-Etsu Chemical Industry Co., Ltd, dimethyl polysiloxane represented by the above formula (I) wherein n is 24.8 on average. The kinematic viscosity at 25° C. is 20 mm²/s.

Dimethyl polysiloxane (X-5): Tradename: KF-96-30cs, manufactured by Shin-Etsu Chemical Industry Co., Ltd, dimethyl polysiloxane represented by the above formula (I) wherein n is 32.9 on average. The kinematic viscosity at 25° C. is 30 mm²/s.

Dimethyl polysiloxane (X-6): Tradename: KF-96-10cs, manufactured by Shin-Etsu Chemical Industry Co., Ltd, dimethyl polysiloxane represented by the above formula (I) wherein n is 12.7 on average. The kinematic viscosity at 25° C. is 10 mm²/s.

Polyisocyanate compound a: TDI-80 (mixture of 2,4-TDI/2,6-TDI=80/20 mass %), isocyanate group content: 48.3 mass % (tradename: CORONATE T-80, manufactured by Nippon Polyurethane Industry Co., Ltd.)

### Examples 1 to 8

A mixture (polyol system) of all materials other than the polyisocyanate compound among the materials and blend agents shown in Tables 1 and 2, was adjusted to a liquid temperature of 22° C.±1° C., and the polyisocyanate compound was adjusted to a liquid temperature of 23±1° C. To the polyol system, the polyisocyanate compound was added in a prescribed amount, followed by mixing for 5 seconds by a mixer (rotational speed: 1,600 rpm), and the mixture was injected at room temperature into a wooden box of 300 mm in length, 300 mm in width and 300 mm in height with an open top and lined with a plastic sheet, to prepare a flexible polyurethane foam (slab foam). The prepared flexible polyurethane foam was taken out and left to stand for 24 hours or more in a room adjusted to have room temperature (23° C.) and a humidity of 50%, whereupon various physical properties were measured. The measured results are shown in Table 1. Here, Examples 1 to 8 are Examples of the present invention, and Examples 9 to 12 are Comparative Examples.

### Examples 13 to 26

A mixture (polyol system) of all materials other than the polyisocyanate compound among the materials and blend agents shown in Tables 3 and 4, was adjusted to a liquid temperature of 22° C.±1° C., and the polyisocyanate compound was adjusted to a liquid temperature of 22±1° C. To the polyol system, the polyisocyanate compound was added in a prescribed amount, followed by mixing for 5 seconds by a mixer (rotational speed: 1,600 rpm), and the mixture was injected at room temperature into a box of 600 mm in length, 600 mm in width and 400 mm in height with an open top and lined with a plastic sheet, to prepare a flexible polyurethane foam (slab foam). The prepared flexible polyurethane foam was taken out and left to stand for 24 hours or more in a room adjusted to have room temperature (23° C.) and a humidity of 50%, whereupon various physical properties were measured. The measured results are shown in Tables 3 and 4. Here, Examples 14 to 19, 21 to 23 and 25 to 26 are Examples of the present invention, and Examples 13, 20 and 24 are Comparative Examples.

Moldability

The moldability was evaluated in such a manner that one having no shrinkage after foaming was identified by ∘ (good), one showing shrinkage and disintegration was identified by x (bad).

Core Density, Rebound Resilience of Core

The core density and the rebound resilience of core were measured by a method in accordance with JIS K6400 (1997 edition). A sample obtained by removing the skin portion from the center portion of the foam and cutting into a size of 100 mm in length, 100 mm in width and 50 mm in height, was used for the measurement.

25% Hardness, Air Permeability, Tensile Strength, Elongation, Dry Heat Compression Set, Wet Heat Compression Set, Hysteresis Loss Rate

The hardness (ILD) with 25% compression, 50% compression and 65% compression, air permeability, tensile strength, elongation, dry heat compression set, wet heat compression set and hysteresis loss rate were measured by methods in accordance with JIS K6400 (1997 edition). Further, the air permeability was measured by a method in accordance with method B of JIS K6400 (1997 edition).

TABLE 1

| | Unit | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Polyether polyol A1 | | 21.2 | 21.2 | 21.2 | 21.2 | 21.2 | 21.0 | 21.2 | 21.2 |
| Polyether polyol B1 | | 29.7 | 29.7 | 29.7 | 29.7 | 29.7 | 29.3 | 29.7 | 29.7 |
| Polyether polyol B2 | | 36.9 | 36.9 | 36.9 | 36.9 | 36.9 | 36.5 | 36.9 | 36.9 |
| Polyether polyol B3 | | 5.4 | 5.4 | 5.4 | 5.4 | 5.4 | 5.4 | 5.4 | 5.4 |
| Polyether polyol C1 | | | | | | | 1.0 | | |
| Polyether monool D1 | | 6.8 | 6.8 | 6.8 | 6.8 | 6.8 | 6.8 | 6.8 | 6.8 |
| Blowing agent | | 1.7 | 1.7 | 1.7 | 1.7 | 1.7 | 1.7 | 1.7 | 1.7 |
| Catalyst A | | 0.1 | 0.1 | 0.1 | 0.1 | 0.1 | 0.1 | 0.1 | 0.2 |
| Catalyst B | | 0.3 | 0.3 | 0.3 | 0.3 | 0.3 | 0.3 | 0.3 | 0.3 |
| Foam stabilizer X-A | | 0.8 | 0.8 | 0.8 | 0.8 | 0.8 | 0.8 | | 0.8 |
| Foam stabilizer X-B | | 0.8 | 0.8 | 0.8 | 0.8 | 0.8 | 0.8 | 0.8 | 0.8 |
| Dimethyl polysiloxane (X-1) | | 0.1 | 0.2 | 0.3 | | | 0.4 | | |
| Dimethyl polysiloxane (X-2) | | | | | 0.2 | | | 0.2 | |
| Dimethyl polysiloxane (X-3) | | | | | | 0.2 | | | |
| Dimethyl polysiloxane (X-4) | | | | | | | | | 0.025 |
| Proportion of dimethyl polysiloxane in | % | 6.25 | 12.5 | 18.75 | 12.5 | 12.5 | 25.0 | 25.0 | 1.56 |
| silicone type compound | | | | | | | | | |
| Isocyanate index | | 104 | 104 | 104 | 104 | 104 | 104 | 104 | 104 |
| Cream time | Sec. | 24 | 24 | 23 | 24 | 24 | 25 | 24 | 24 |
| Rise time | Sec. | 155 | 159 | 157 | 169 | 158 | 159 | 168 | 129 |
| Moldability | | ◯ | ◯ | ◯ | ◯ | ◯ | ◯ | ◯ | ◯ |
| Core density | kg/m³ | 49.0 | 49.1 | 48.9 | 49.9 | 48.6 | 48.5 | 48.9 | 49.1 |
| Thickness of foam at the time of measuring | mm | 49.3 | 49.2 | 49.1 | 49.1 | 49.4 | 49.3 | 49.4 | 49.3 |
| hardness | | | | | | | | | |
| Hardness with 25% compression | N/314 cm² | 82 | 82 | 81 | 82 | 82 | 86 | 82 | 79 |
| Hardness with 50% compression | N/314 cm² | 121 | 121 | 120 | 121 | 120 | 124 | 122 | 116 |
| Hardness with 65% compression | N/314 cm² | 178 | 180 | 178 | 180 | 177 | 186 | 181 | 173 |
| Hardness with 65% compression/hardness | — | 2.17 | 2.20 | 2.20 | 2.20 | 2.16 | 2.17 | 2.21 | 2.19 |
| with 25% compression | | | | | | | | | |
| Air permeability | L/min | 31.0 | 33.5 | 44.8 | 46.8 | 31.5 | 50.3 | 43.5 | 49.3 |
| Rebound resilience of core | % | 8 | 9 | 10 | 10 | 7 | 11 | 10 | 9 |
| Dry heat compression set with 50% compression | % | 3.6 | 3.4 | 4.2 | 2.7 | 3.5 | 4.3 | 2.5 | 4.0 |
| Wet heat compression set with 50% compression | % | 2.9 | 2.8 | 2.9 | 2.0 | 2.3 | 3.0 | 2.3 | 2.4 |
| Dry heat compression set with 90% compression | % | 7.6 | 7.3 | 5.1 | 6.1 | 6.3 | 5.4 | 5.2 | 5.1 |
| Wet heat compression set with 90% compression | % | 2.7 | 2.8 | 3.4 | 2.7 | 3.8 | 3.5 | 3.5 | 2.7 |
| Hysteresis loss rate | % | 40.9 | 40.3 | 39.5 | 39.5 | 41.8 | 39.9 | 39.8 | 35.7 |

TABLE 2

| | Unit | Ex. 9 | Ex. 10 | Ex. 11 | Ex. 12 |
|---|---|---|---|---|---|
| Polyether polyol A1 | | 21.2 | 21.2 | 20.8 | 19.2 |
| Polyether polyol B1 | | 29.7 | 29.7 | 29.2 | 26.9 |
| Polyether polyol B2 | | 36.9 | 36.9 | 33.3 | 30.8 |
| Polyether polyol B3 | | 5.4 | 5.4 | | |
| Polyether monool D1 | | 6.8 | 6.8 | 16.7 | 23.1 |
| Blowing agent | | 1.7 | 1.7 | 1.33 | 1.37 |
| Catalyst A | | 0.1 | 0.2 | | |
| Catalyst B | | 0.3 | 0.3 | | |
| Catalyst C | | | | 0.28 | 0.29 |
| Catalyst D | | | | 0.12 | 0.19 |
| Foam stabilizer X-A | | 0.8 | 0.8 | | |
| Foam stabilizer X-B | | 0.8 | 0.8 | | |
| Foam stabilizer X-C | | | | 0.28 | 0.29 |
| Dimethyl polysiloxane (X-5) | | | 0.025 | | |
| Proportion of dimethyl polysiloxane in | % | 0 | 12.5 | 0 | 0 |
| silicone type compound | | | | | |
| Isocyanate index | | 104 | 104 | 107 | 107 |
| Cream time | Sec. | 25 | 23 | 21 | 22 |
| Rise time | Sec. | 162 | Collapse | 280 | 288 |
| Moldability | | ◯ | X | ◯ | ◯ |
| Core density | kg/m³ | 48.4 | | 61.5 | 58.3 |
| Thickness of foam at the time of | mm | 49.2 | | 49.5 | 49.5 |
| measuring hardness | | | | | |
| Hardness with 25% compression | N/314 cm² | 83 | | 80 | 65 |
| Hardness with 50% compression | N/314 cm² | 122 | | 126 | 102 |
| Hardness with 65% compression | N/314 cm² | 180 | | 185 | 148 |
| Hardness with 65% compression/hardness | — | 2.17 | | 2.31 | 2.28 |
| with 25% compression | | | | | |
| Air permeability | L/min | 9.8 | | 60.0 | 91.5 |
| Rebound resilience of core | % | 7 | | 9 | 11 |
| Dry heat compression set with 50% compression | % | 3.5 | | 3.7 | 4.0 |
| Wet heat compression set with 50% compression | % | 2.7 | | 2.8 | 3.7 |
| Dry heat compression set with 90% compression | % | 4.4 | | 15.9 | 13.5 |
| Wet heat compression set with 90% compression | % | 3.5 | | 10.8 | 10.5 |
| Hysteresis loss rate | % | 41.5 | | 35.1 | 43.1 |

TABLE 3

| | Unit | Ex. 13 | Ex. 14 | Ex. 15 | Ex. 16 | Ex. 17 | Ex. 18 | Ex. 19 |
|---|---|---|---|---|---|---|---|---|
| Polyether polyol A1 | | 21.2 | 21.2 | 21.2 | 21.2 | 21.2 | 21.2 | 21.2 |
| Polyether polyol B1 | | 29.7 | 29.7 | 29.7 | 29.7 | 29.7 | 29.7 | 29.7 |
| Polyether polyol B2 | | 36.9 | 36.9 | 36.9 | 36.9 | 36.9 | 36.9 | 36.9 |
| Polyether polyol B3 | | 5.4 | 5.4 | 5.4 | 5.4 | 5.4 | 5.4 | 5.4 |
| Polyether monool D1 | | 6.8 | 6.8 | 6.8 | 6.8 | 6.8 | 6.8 | 6.8 |
| Blowing agent | | 1.7 | 1.7 | 1.7 | 1.7 | 1.7 | 1.7 | 1.7 |
| Catalyst A | | 0.2 | 0.1 | 0.1 | 0.1 | 0.1 | 0.1 | 0.1 |
| Catalyst B | | 0.3 | 0.3 | 0.3 | 0.3 | 0.3 | 0.3 | 0.3 |
| Foam stabilizer X-A | | 0.8 | 0.8 | 0.8 | 0.8 | 0.8 | 0.8 | 0.8 |
| Foam stabilizer X-B | | 0.8 | 0.8 | 0.8 | 0.8 | 0.8 | 0.8 | 0.8 |
| Dimethyl polysiloxane (X-1) | | | 0.1 | 0.2 | 0.3 | | | |
| Dimethyl polysiloxane (X-2) | | | | | | 0.1 | 0.2 | 0.3 |
| Proportion of dimethyl polysiloxane in | % | 0 | 6.25 | 12.5 | 18.75 | 6.25 | 12.5 | 18.75 |
| silicone type compound | | | | | | | | |
| Isocyanate index | | 104 | 104 | 104 | 104 | 104 | 104 | 104 |
| Cream time | Sec. | 23 | 23 | 23 | 24 | 25 | 25 | 25 |
| Rise time | Sec. | 135 | 137 | 137 | 128 | 131 | 131 | 123 |
| Moldability | | ◯ | ◯ | ◯ | ◯ | ◯ | ◯ | ◯ |
| Core density | kg/m³ | 48.3 | 48.1 | 48.7 | 48.6 | 48.9 | 48.4 | 51.8 |
| Thickness of foam at the time of measuring hardness | mm | 49.7 | 49.4 | 49.7 | 49.6 | 49.8 | 49.8 | 49.8 |
| Hardness with 25% compression | N/314 cm² | 87 | 81 | 81 | 78 | 77 | 72 | 75 |
| Hardness with 50% compression | N/314 cm² | 131 | 122 | 122 | 118 | 118 | 110 | 119 |
| Hardness with 65% compression | N/314 cm² | 192 | 179 | 179 | 173 | 173 | 162 | 178 |
| Hardness with 65% compression/hardness | — | 2.21 | 2.21 | 2.21 | 2.22 | 2.25 | 2.25 | 2.37 |
| with 25% compression | | | | | | | | |
| Air permeability | L/min | 23.8 | 59.3 | 58.3 | 81.3 | 60.3 | 81.3 | 39.5 |
| Rebound resilience of core | % | 10 | 10 | 11 | 11 | 10 | 10 | 10 |
| Dry heat compression set with 50% compression | % | 3.1 | 3.0 | 3.0 | 2.9 | 3.1 | 3.0 | 3.2 |
| Wet heat compression set with 50% compression | % | 2.5 | 2.5 | 2.1 | 1.9 | 2.5 | 2.1 | 2.5 |
| Dry heat compression set with 90% compression | % | 6.9 | 5.2 | 4.9 | 4.6 | 5.3 | 4.5 | 4.8 |
| Wet heat compression set with 90% compression | % | 2.5 | 1.9 | 1.8 | 1.8 | 2.1 | 1.8 | 2.3 |
| Hysteresis loss rate | % | 40.2 | 37.5 | 36.7 | 36.2 | 37.9 | 36.4 | 37.2 |

TABLE 4

| | Unit | Ex. 20 | Ex. 21 | Ex. 22 | Ex. 23 | Ex. 24 | Ex. 25 | Ex. 26 |
|---|---|---|---|---|---|---|---|---|
| Polyether polyol A1 | | 21.7 | 21.7 | 21.7 | 21.7 | 22 | 22 | 22 |
| Polyether polyol B1 | | 30.5 | 30.5 | 30.5 | 30.5 | 31 | 31 | 31 |
| Polyether polyol B2 | | 37.8 | 37.8 | 37.8 | 37.8 | 38.4 | 38.4 | 38.4 |
| Polyether polyol B3 | | 3.0 | 3.0 | 3.0 | 3.0 | 1.5 | 1.5 | 1.5 |
| Polyether monool D1 | | 7.0 | 7.0 | 7.0 | 7.0 | 7.1 | 7.1 | 7.1 |
| Blowing agent | | 2.6 | 2.6 | 2.6 | 2.6 | 4.2 | 4.2 | 4.2 |
| Catalyst A | | 0.35 | 0.35 | 0.35 | 0.25 | 0.45 | 0.45 | 0.45 |
| Catalyst B | | 0.2 | 0.2 | 0.2 | 0.2 | 0.2 | 0.2 | 0.2 |
| Foam stabilizer X-A | | 0.8 | 0.8 | 0.8 | 0.8 | 0.8 | 0.8 | 0.8 |
| Foam stabilizer X-B | | 0.8 | 0.8 | 0.8 | 0.8 | 0.8 | 0.8 | 0.8 |
| Dimethyl polysiloxane (X-1) | | | | 0.4 | | | | |
| Dimethyl polysiloxane (X-2) | | | 0.4 | | | | 0.5 | |
| Dimethyl polysiloxane (X-6) | | | | | 0.15 | | | |
| Proportion of dimethyl polysiloxane in | % | 0 | 25 | 25 | 9.37 | 0 | 31.25 | 31.25 |
| silicone type compound | | | | | | | | |
| Isocyanate index | | 104 | 104 | 104 | 104 | 103 | 103 | 103 |
| Cream time | Sec. | 23 | 25 | 24 | 20 | 18 | 19 | 20 |
| Rise time | Sec. | 105 | 100 | 103 | 97 | 68 | 66 | 67 |
| Moldability | | ◯ | ◯ | ◯ | ◯ | ◯ | ◯ | ◯ |
| Core density | kg/m³ | 34.3 | 35.6 | 35.4 | 34.8 | 23.6 | 24.3 | 24.0 |
| Thickness of foam at the time of measuring hardness | mm | 50.1 | 50.1 | 50.0 | 50.4 | 49.7 | 49.8 | 49.4 |
| Hardness with 25% compression | N/314 cm² | 93 | 95 | 96 | 74 | 125 | 122 | 123 |
| Hardness with 50% compression | N/314 cm² | 136 | 140 | 140 | 117 | 196 | 193 | 193 |
| Hardness with 65% compression | N/314 cm² | 196 | 203 | 202 | 171 | 291 | 287 | 286 |
| Hardness with 65% compression/hardness | — | 2.11 | 2.14 | 2.10 | 2.31 | 2.33 | 2.35 | 2.33 |
| with 25% compression | | | | | | | | |
| Air permeability | L/min | 25.9 | 93.4 | 105.9 | 63.8 | 29.6 | 121.1 | 145.3 |
| Rebound resilience of core | % | 9 | 9 | 9 | 12 | 11 | 13 | 14 |
| Dry heat compression set with 50% compression | % | 3.2 | 3.0 | 3.1 | 4.1 | 8.8 | 9.2 | 9.5 |
| Wet heat compression set with 50% compression | % | 4.9 | 4.4 | 4.5 | 5.8 | 9.9 | 9.8 | 9.7 |
| Dry heat compression set with 90% compression | % | 5.3 | 5.0 | 5.0 | 7.6 | 14.4 | 11.4 | 11.9 |
| Wet heat compression set with 90% compression | % | 5.8 | 5.5 | 5.4 | 7.8 | 15.4 | 9.5 | 9.8 |
| Hysteresis loss rate | % | 53.3 | 50.1 | 51.6 | 51.3 | 69.5 | 66.2 | 66.8 |

With the flexible polyurethane foams in Examples 1 to 8 prepared by using the specific polyols (A), (B) and (C), monool (D) and the specific dimethyl polysiloxane, as shown in Table 1, the rebound resilience was at most 15%, and as indices for the durability, the dry heat compression set with 50% compression was as small as at most 5% and the dry heat compression set with 90% compression was as small as at most 10%, and thus, the durability was good. Further, the air permeability was also at least 30 L/min, thus showing that flexible polyurethane foams having very high air permeability were obtained. On the other hand, in Example 9, the flexible polyurethane foam obtained was poor in air permeability, since the specific dimethyl polysiloxane was not used. Further, if dimethyl polysiloxane wherein n=32.9 was used in an amount of 0.025 part by mass, the degree of cell interconnection was very high at the time of forming a flexible polyurethane foam, and therefore the foam collapsed.

Further, in Examples 11 and 12, the proportion of the monool exceeded 15 mass %, and therefore it was possible to obtain a flexible polyurethane foam which could secure very high air permeability without using the dimethyl polysiloxane (I) of the present application, but the dry heat compression set and wet heat compression set with 90% compression were deteriorated.

With the flexible polyurethane foams in Examples 14 to 19, as shown in Table 3, the moldability was good even by foaming in a large size. Further, the rebound resilience was at most 15%, and the dry heat compression set as an index of the durability was also small, and thus, the durability was good. Further, the air permeability was also at least 30 L/min, thus showing that flexible polyurethane foams having very high air permeability were obtained. Further, in Example 13, no specific dimethyl polysiloxane was used, and therefore the air permeability was at most 30 L/min.

In Examples 21 to 23 and 25 to 26, the specific polyols (A), (B) and (C), monool (D) and the specific dimethyl polysiloxane were used to prepare a flexible polyurethane foam which was light in weight. These flexible polyurethane foams could secure high air permeability, as compared with the foams in Examples 20 and 24 where no specific dimethyl polysiloxane was used.

### Example 27

### Example of the Present Invention

A mixture (polyol system) of all materials other than the polyisocyanate compound among the materials and blend agents shown in Example 3 in Table 1, was adjusted to a liquid temperature of 23° C.±1° C., and the polyisocyanate compound was adjusted to a liquid temperature of 22±1° C. To the polyol system, the polyisocyanate compound was added in a prescribed amount, followed by mixing for 5 seconds by a mixer (rotational speed: 3,000 rpm), and the obtained mixed liquid was immediately injected into an aluminum mold (400 mm in length, 400 mm in width and 100 mm in height) heated to 60° C. and sealed. After maintaining the mold temperature at 60° C. for 10 minutes, the flexible polyurethane foam was taken out from the mold.

As a result, the flexible polyurethane foam (mold foam) was prepared with good moldability. Further, the prepared flexible polyurethane foam was aged for at least 24 hours at 23° C. under a relative humidity of 50%, whereupon various physical properties were measured. As a result, a flexible polyurethane foam having a low rebound resilience and excellent air permeability was prepared, which had a core density of 58.3 kg/m³, a rebound resilience of core of 6% and an air permeability of 33.5 L/min.

### INDUSTRIAL APPLICABILITY

The flexible polyurethane foam of the present invention has low resilience, and it is suitable as a shock absorber, a sound absorbent or a vibration absorber, and also suitable for bedding, mats, cushions, seat cushions for automobiles, backing materials or skin wadding materials by frame lamination. It is particularly suitable for bedding (mattress, pillows, etc.) since it is excellent in the durability in a humid and hot state and the air permeability.

What is claimed is:

1. A process for producing a flexible polyurethane foam, which comprises reacting a polyol mixture containing the following polyol (A), the following polyol (B) and the following monool (D), with a polyisocyanate compound, in the presence of a foam stabilizer (X) which is a silicone type compound, a urethane-forming catalyst and a blowing agent, at an isocyanate index of at least 90, wherein:
Polyol (A) is a polyether polyol having an average number of hydroxy groups of from 2 to 3 and a hydroxy value of from 10 to 90 mgKOH/g, obtained by ring-opening addition polymerization of an alkylene oxide to an initiator by using a double metal cyanide complex catalyst;
Polyol (B) is a polyether polyol having an average number of hydroxy groups of from 2 to 3 and a hydroxy value of from 15 to 250 mgKOH/g, other than the polyol (A);
Monool (D) is a polyether monool having a hydroxy value of from 10 to 200 mgKOH/g, obtained by ring-opening addition polymerization of an alkylene oxide to an initiator by using a double metal cyanide complex catalyst; and
Foam stabilizer (X) is a silicone type compound containing one or more types of dimethylpolysiloxane represented by the following formula (I): 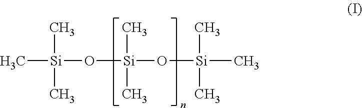
where n is from 1 to 30 on average,
in an amount of from 0.01 to 1.0 part by mass per 100 parts by mass of the above polyol mixture.

2. The process for producing a flexible polyurethane foam according to claim 1, wherein the foam stabilizer (X) is contained in an amount of from 0.1 to 8.0 parts by mass per 100 parts by mass of the above polyol mixture.

3. The process for producing a flexible polyurethane foam according to claim 1, wherein the dimethylpolysiloxane represented by the formula (I) is contained in an amount of from 0.7 to 95.0 mass % in 100 mass % of the foam stabilizer (X).

4. The process for producing a flexible polyurethane foam according to claim 1, wherein the polyol (A) is contained in an amount of from 10 to 30 mass %, the polyol (B) is contained in an amount of from 50 to 80 mass %, and the monool (D) is contained in an amount of from 2 to 24 mass %, in the polyol mixture.

5. The process for producing a flexible polyurethane foam according to claim 1, wherein the polyol (A) is a polyoxypropylene polyol obtained by ring-opening addition polymerization of only propylene oxide to an initiator.

6. The process for producing a flexible polyurethane foam according to claim 1, wherein the blowing agent is water.

7. The process for producing a flexible polyurethane foam according to claim 1, wherein the monool (D) is a polyoxypropylene monool obtained by ring-opening addition polymerization of only propylene oxide to an initiator.

8. The process for producing a flexible polyurethane foam according to claim 1, wherein the polyisocyanate compound is at least one member selected from the group consisting of tolylene diisocyanate (TDI), diphenylmethane diisocyanate (MDI), polymethylenepolyphenyl polyisocyanate, xylylene diisocyanate (XDI), isophorone diisocyanate (IPDI), hexamethylene diisocyanate (HMDI) and their modified products.

9. The process for producing a flexible polyurethane foam according to claim 1, wherein the polyol mixture further contains the following polyol (C) in an amount of at most 10 mass % based on the entire polyol mixture:
Polyol (C) is a polyol having an average number of hydroxy groups of from 2 to 6 and a hydroxy value of from 300 to 1,830 mgKOH/g.

10. The process for producing a flexible polyurethane foam according to claim 1, wherein the flexible polyurethane foam has a rebound resilience of the core of at most 20% and an air permeability of from 30 to 160 L/min.

11. The process for producing a flexible polyurethane foam according to claim 1, wherein the flexible polyurethane foam has a hysteresis loss rate of the core, measured in accordance with JIS K6400 (1997), of at most 70%.
